(19) United States
(12) Patent Application Publication
(10) Pub. No.: US 2005/0021359 A1
(43) Pub. Date: Jan. 27, 2005

(54) Monitoring system and method

(76) Inventor: Jerry L. McKinney, Silsbee, TX (US)

Correspondence Address: Browning Bushman P.C., Suite 1800, 5718 Westheimer, Houston, TX, 77057, US

(21) Appl. No.: 10/859,685

(22) Filed: Jun. 3, 2004

Related U.S. Application Data
(63) Continuation-in-part of application No. 10/003,633, filed on Nov. 2, 2001.

(51) Int. Cl. G06F 17/60

(52) U.S. Cl. 705/1; 702/187

(57) ABSTRACT

The present invention provides an electronic system and method that permits a responsible parties to determine whether services such as maintenance and repairs have been timely made on environmental equipment installations, such as homeowner wastewater treatment plants, to comply with regulatory requirements. The environmental equipment installations may be installed at different locations, operating on different inspection schedules, with different service companies, different owners, of different types, and be of different processing capacity. A personnel detector is preferably utilized to verify the actual physical presence of service personnel. In a preferred embodiment, the system provides a scheduler for service companies whereby information regarding service schedules and required repairs is available online. The scheduler is operable for generating service routes based on present requirements and/or for providing maps to locations for service personnel.

### CROSS REFERENCE TO RELATED APPLICATION

This application is a continuation-in-part application of U.S. patent application Ser. No. 10/003,633 filed on Nov. 2, 2001.

### BACKGROUND OF THE INVENTION

1. Field of the Invention

The present invention relates generally to monitoring systems and, in a presently preferred embodiment, provides a system and method for servicing and for verifying compliance related to maintenance, operation, inspection, repair, and/or service contract renewal status of environmental equipment such as wastewater treatment systems.

2. Description of the Prior Art

Large municipal wastewater treatment plants employ daily personnel to monitor and maintain the plants; however, homeowners who live in non-municipal areas must often supply their own home wastewater treatment plant. Many low volume wastewater treatment plants are owned by individual homeowners or small entities who cannot realistically afford to employ personnel on a daily basis to maintain and repair their wastewater treatment facility.

Due to the high costs of daily service personnel for small systems, environmental regulations may require that manufacturers of small wastewater treatment systems be certified to make, sell, and service suitable systems and then permit the smaller certified systems to be inspected and tested on a less frequent, but periodic, basis, such as quarterly, biannually, and the like. A system may be certified after extensive testing of the system design by a suitable certification entity. Environmental regulations/certifications may also require automatic detection of system problems, e.g., a pump failure or other types of failures. If a problem is detected, regulations/certifications may also require that service personnel arrive within a relatively short time, e.g., within forty-eight hours, to promptly correct the problem. If the systems do not operate properly, then untreated wastewater from the system may eventually reach local streams. If such problems occur frequently with thousands of small systems, then environmental problems could result.

Therefore, environmental regulations/certifications relating to regular maintenance and inspection, as well as prompt repairs of wastewater treatment systems, are necessary and desirable to protect the environment. In some cases, non-governmental companies, such as NSF®, have been created to provide certification of equipment for compliance with NSF® requirements that relate to regulations, rules, and/or standards for such systems. Certification requirements may relate to maintenance, inspection, and repairs, as well as technical requirements for system outputs/operation such as suspended solids, pH, temperature, dissolved oxygen, color, oily film, foam, noise, biochemicals, odor, reliability, and the like. Thus, as used herein, environmental regulatory bodies may include governmental agencies, municipal governments, other governmental organizations, and private companies that effectively provide rules, standards, regulations, certifications, and the like for wastewater systems.

Due to such regulations, rules, and standards, which may vary from state to state, monitoring systems are presently available for wastewater treatment systems. Upon sensing a problem in the wastewater system, the monitoring systems may be required to produce a visual and auditory warning that will normally be readily detected by the homeowner. In this way, ideally, the homeowner would promptly contact his service company for repairs, and ideally, the service company would promptly repair the problem within the time limit required by regulation/certification. Some regulations require that the service company name be displayed on the system to permit easier contacting of the service company by the homeowner. Some systems provide a telephone dialer to directly contact the service company in case the homeowner does not recognize the problem immediately or see/hear the monitor warning signals. In some cases, the telephone dialer provides two-way communication to provide the ability for additional testing and remote servicing to thereby save service costs. In some cases, regulations may also require stickers and punch-out cards with the maintenance schedule mounted to the systems to verify that scheduled maintenance and/or testing has been timely performed. Nonprofit organizations, such as NSF®, may be used and/or required to certify the type of equipment for suitable operation and certify that the manufacturer provides suitable maintenance plans for the equipment owner and personnel qualified to maintain the equipment. Homeowners often are required to purchase a maintenance plan for a service time, such as two years, with the manufacturers or other service providers who are certified to install and maintain such plans. Homeowners are often required by regulations to renew their initial service contract, which may be for two years, for as long as the equipment is utilized; however, after extensive review and research in this industry, the inventor has identified significant problems that still exist with such systems and that are discussed hereinafter in some detail. For instance, when Homeowners obtain a service contract, it is often difficult for Homeowners to verify that the required maintenance has actually been performed and that repairs have been made by the service companies in a timely manner.

Computer programs exist which permit scheduling of service personnel. However, such computer programs require significant amounts of data to be input by the service company, e.g, the maintenance schedule for each environmental system and/or the occurrences of automatically generated warnings that repairs are required. Moreover, such computer programs are expensive.

Consequently, there remains a need to provide an improved monitoring system to protect the environment. Those of skill in the art will appreciate the present invention, which addresses the above problems and other significant problems uncovered by the inventor that are discussed hereinafter.

### SUMMARY OF THE INVENTION

Accordingly, it is an objective of the present invention to provide an improved system and method capable of monitoring a plurality of environmental equipment systems.

An objective of one preferred embodiment of the present invention is to provide an improved system and method that permits responsible parties to automatically monitor compliance by their service provider in providing maintenance and repairs to their environmental equipment systems.

An objective of another preferred embodiment of the present invention is to provide a computerized network for collecting/processing/organizing/disseminating data from the plurality of environmental equipment systems, including operational data; service personnel data; event time stamp data; responsibility data, such as ownership or other responsibility of the plurality of environmental equipment systems; and status data regarding maintenance contracts for the plurality of systems.

Yet another objective of a preferred embodiment of the present invention is to provide an improved means for service companies to schedule required installation services.

These and other objectives, features, and advantages of the present invention will become apparent from the drawings, the descriptions given herein, and the appended claims. However, it will be understood that above-listed objectives and/or advantages of the invention are intended only as an aid in understanding aspects of the invention, are not intended to limit the invention in any way, and therefore do not form a comprehensive or restrictive list of objectives, and/or features, and/or advantages.

Accordingly, in one embodiment the present invention provides for a method to monitor a plurality of environmental equipment systems with respect to timely servicing. The environmental equipment systems are serviced by one or more service personnel from one or more service companies. A plurality of responsible parties are responsible for payment to the one or more service companies for the servicing. The method may comprise one or more steps such as, for example, electronically sensing operational data which comprises occurrences of equipment problems for the plurality of environmental equipment systems, electronically storing inspection data related to scheduled inspection requirements of the one or more service personnel for each of the plurality of environmental equipment systems, and/or producing personnel data related to a physical presence of the one or more service personnel at the plurality of environmental equipment systems. Other steps may comprise producing clock data which may comprise times/dates of the occurrences of equipment problems, of the scheduled inspection requirements, and the physical presence of the one or more service personnel and/or electronically providing access to the operational data, the inspection data, the personnel data, and the clock data to the plurality of responsible parties for those environmental equipment systems for which each of the plurality of responsible parties is responsible.

In one preferred embodiment, the step of producing clock data further comprises providing a physical presence sensor for sensing the physical presence of the one or more service personnel at each of the plurality of environmental equipment systems.

In a presently preferred embodiment, the step of electronically providing access further comprises generating a website accessible by the plurality of responsible parties. Preferably, the website access for the plurality of responsible parties is limited to data for only those of the plurality of environmental systems with which each of the plurality of responsible parties is associated.

Preferably, the method may further comprise electronically sending accumulated reports relating to the operational data, the personnel data, the clock data, and the inspection data to at least one regulatory body having responsibilities concerning the plurality of environmental equipment systems and/or generating notices related to noncompliance the timely servicing for transmission to the responsible parties and/or generating noncompliance notices indicating failure to renew service contracts.

As well, a monitoring system is provided which may comprise one or more elements such as, for example, an electronic monitor operable for monitoring repair status of each of the plurality of environmental equipment systems and for producing a warning that repairs are required, at least one data storage element for electronically storing when the repairs are required and when the repairs are made, the at least one data storage element being further operable for storing when scheduled maintenance is required and when the scheduled maintenance is made and/or electronic linkage with the one or more service companies, the plurality of responsible parties, and the regulatory body. The electronic linkage permits the responsible parties to determine from the at least one data storage element whether the scheduled maintenance and the repairs are timely made.

In another embodiment, a method for servicing a plurality of environmental equipment systems is provided which may comprise one or more elements such as, for example, electronically sensing repair status of each of the plurality of environmental equipment systems, automatically producing a warning when repairs are required in response to the electronically sensing for each of the plurality of environmental equipment systems, automatically storing time, date, and location data relating to the each warning, electronically storing inspection data related to scheduled inspection requirements of the one or more service personnel for each of the plurality of environmental equipment systems and generating a web site accessible by each of the plurality of service companies to retrieve service data relating to when and where repairs and servicing of the plurality of environmental equipment systems is due.

The method may further comprise selectively automatically generating a service schedule for one or more service personnel based on the service data which provides a list of environmental equipment systems where service is presently due. The method may further comprise selectively automatically generating a plurality of service schedules for each of a plurality of service personnel, wherein each service schedule provides a list of environmental equipment systems to be serviced by each service personnel during a particular time period, e.g., a daily work schedule.

The method may further comprise selectively generating maps for a location of each environmental equipment system for each of the service schedules. The method may further comprise selectively automatically generating a travel route to environmental equipment systems on each service schedule.

The method may further comprise electrically detecting a time and date of a presence of service personnel at each of the plurality of environmental equipment systems, providing access to this information to the plurality of service companies and/or providing access to the website to the responsible parties so that the responsible parties can determine whether maintenance and repairs were made within required times.

A servicing system for a plurality of environmental equipment systems is also provided which system may comprise one or more elements such as an electronic monitor for monitoring repair status of each of the plurality of environmental equipment systems and for producing a warning that repairs are required, at least one data storage element for electronically storing when the repairs are required and when scheduled maintenance is required, electronic linkage with the plurality of service companies whereby access to service data relating to when the repairs are required and when scheduled maintenance is required, and/or a scheduler operable for utilizing the service data retrieved through the electronic linkage to selectively automatically generate a plurality of service schedules for the service personnel at each of the plurality of service companies, each service schedule may comprise a separate list of environmental equipment systems requiring service.

The scheduler is preferably operable for selecting environmental equipment systems for each service schedule based on the physical location of the environmental equipment system. For instance, the scheduler may be operable to group proximately located environmental equipment systems together in producing the service schedules.

In one embodiment, the scheduler is operable to automatically generate a proposed route for traveling to each environmental equipment system on a respective service schedule. The automatically generated proposed route is preferably modifiable by a user. The scheduler is preferably operable to generate a map for each environmental equipment system on a respective service schedule.

The scheduler is operable to list whether repairs or maintenance are required for each environmental equipment system on each respective service schedule. The servicing system of may further comprise an electric physical presence detector for producing personnel data related to when the service personnel are present at the plurality of environmental equipment systems. The scheduler is preferably made available on a website.

The present invention may provide an electronic regulatory compliance method for one or a plurality of environmental equipment systems. In this case, the environment equipment systems may be installed, if desired, at a plurality of different locations and may have, if desired, a plurality of different owners. If desired, the environmental equipment system(s) may be serviced by one or more service companies having one or more service personnel. A regulatory body is responsible for monitoring the environmental equipment systems with respect to scheduled inspection and timely repair of the environmental equipment systems. The method may comprise one or more steps, such as, for instance, automatically monitoring for operational status, such as equipment problems or the lack of equipment problems at each of the environmental equipment systems, automatically notifying the one or more service companies of the operational problems detected at the environmental equipment systems, electronically detecting a physical presence of the one or more service personnel at the environmental equipment systems, electronically storing inspection data related to the scheduled inspections requiring the physical presence of the one or more service personnel for each of the environmental equipment systems, automatically storing the operational data related to the operational problems detected at each of the environmental equipment systems, automatically storing the personnel data related to the physical presence of the one or more service personnel at the each of environmental equipment systems, and/or generating a report for the regulatory body related to compliance with the scheduled inspection and timely repairs for each of the environmental equipment systems.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is a schematic block diagram of an environmental compliance system in accord with the present invention;

FIG. 2 is a schematic block diagram of one possible preferred embodiment showing a configuration of interconnections for an environmental compliance system in accord with the present invention;

FIG. 3 is a schematic flow diagram relating to operation of an event data transmitter that may be utilized by each of a plurality of environmental equipment systems in accord with one possible preferred embodiment of the present invention;

FIG. 4 is a schematic flow diagram relating to operation of an event data receiver that may be utilized to receive data from a plurality of event data transmitters such as those described by FIG. 4 in accord with one possible preferred embodiment;

FIG. 5 is a block diagram for a website that may be accessed by a regulatory agent to obtain data related to compliance with regulatory requirements, such as scheduled maintenance, timely repairs, maintenance contracts, and responsible parties, for a plurality of environmental equipment systems located in different locations in accord with one possible embodiment of the present invention; and

FIG. 6 is a schematic showing a process of computerized scheduling of service personnel in accord with one possible embodiment of the present invention.

### DETAILED DESCRIPTION OF THE PREFERRED EMBODIMENTS

With small wastewater treatment systems, the systems may be serviced by different service companies, owned by different owners, and located at different locations. Generally, as used herein, different locations will also refer to different portions of land typically owned by different owners. The locations may be adjacent each other or separated by thousands of miles; however, the invention could also be utilized to monitor multiple environmental equipment systems on premises owned by a single owner such as a large plant, refinery, or the like with many different systems spread out over a wide area. The invention could also be utilized by a plurality of such plants or refineries located in different geographical areas of a country or in different countries to thereby permit improved compliance control by appropriate regulatory bodies.

Monitoring systems for environmental equipment such as wastewater treatment systems are known, as discussed hereinbefore; however, the inventor has determined that the following problems still exist that prevent or frustrate reliable environmental regulation oversight by the appropriate environmental regulatory body(s). The regulatory body typically has a limited number of employees and limited funds, and therefore has limited ability to conduct investigations of thousands (or tens or hundreds of thousands) of separately owned home wastewater treatment facilities to verify compliance with regulations. For instance, it is presently impractical for a regulatory body to reliably verify occurrence of equipment failures at each of thousands of homeowner wastewater treatment facilities and whether the equipment failures are timely reported or reported at all. Even for those systems that automatically report failures to the service company, the regulatory body has no practical way of determining if and when repairs have been made. Moreover, if the homeowner decides not to renew a maintenance contract with a certified service company, the regulatory body has little or no practical way of determining the renewal status of the maintenance contract without use of extensive personnel time. If repairs are made, there is also no practical way for the regulatory body to determine whether repairs have been made within the time period, e.g., forty-eight hours, that is required by the regulations. As well, there is no practical way for the regulatory body to determine, without extensive investigative time and money, whether routine inspections are consistently made according to the inspection schedules required by regulations and/or certification rules. For that matter, even the installation owner who may be ultimately responsible for compliance with regulations, such as a homeowner, may not know whether routine inspections in accordance with the terms of the service contract for which the installation owner pays are made as per regulations and/or whether repairs were made in a timely manner.

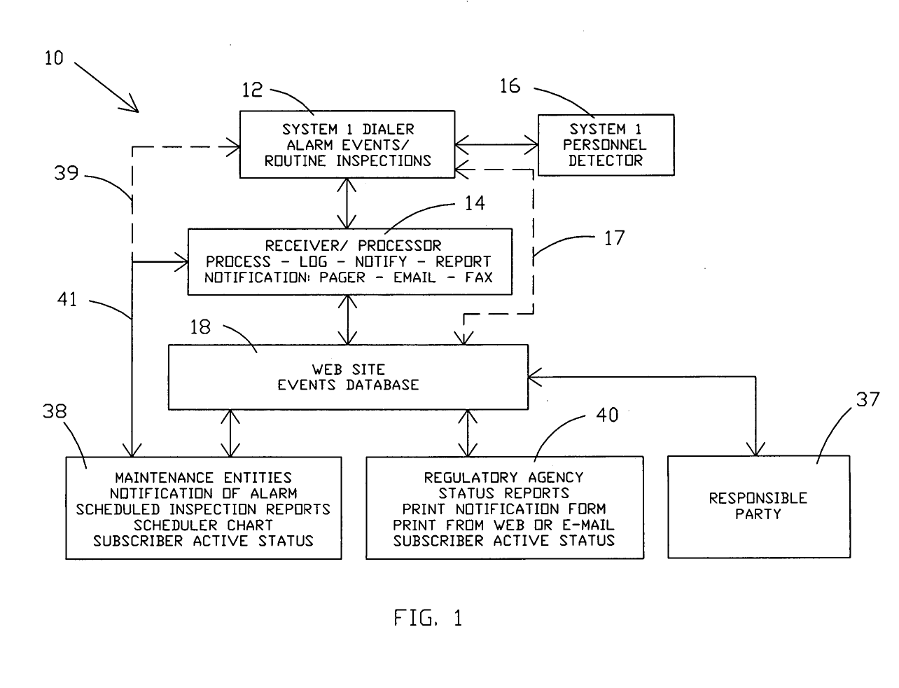

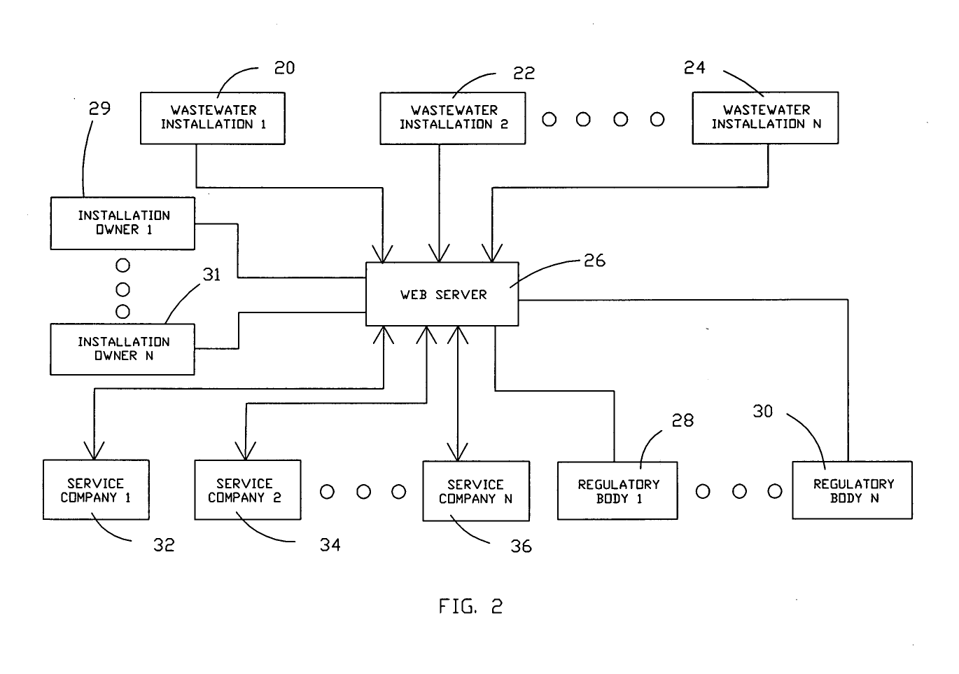

With reference now to the drawings, and more particularly to FIG. 1, there is shown a presently preferred regulatory compliance system 10 in accord with the present invention. Compliance system 10 provides for remote monitoring and notification for use with a plurality of environmental equipment systems with different service companies and different owners. In the presently preferred embodiment, controller 12 may be mounted with each of a plurality of different environmental equipment systems, e.g., wastewater treatment systems, to collect data from each system and communicate the data from the plurality of systems to receiver 14, where the data is collected and stored. In FIG. 1, controller 12 is illustrated for use with a single system 1, but as shown in FIG. 2, a plurality of controllers 12 may preferably be utilized with any number N of wastewater systems as designated by numerals 20, 22, and 24. Thus, FIG. 1 discloses the basic operation of the invention with one environmental equipment system, but the present invention is most highly useful for efficiencies achieved when monitoring large numbers of units in the range of thousands and ten thousands of units or more.

The alarm events detected by controller 12 may be for a wide variety of events that use different sensors for producing an alarm signal. For instance, pump pressures, motor currents/voltages, fluid levels, component temperatures, effluent properties, and the like may be used to indicate normal operation, operation failure, impending failure, need for servicing, and the like. The information for each event may be stored and/or transmitted in any desired manner and may be controlled by suitable programming and/or circuitry.

In a presently preferred embodiment, service personnel detector 16 is provided to detect the physical presence of service personnel who are generally required by regulations to inspect the environmental equipment in accord with an inspection schedule and to timely repair the environmental equipment whenever repair is required according to the different sensors discussed above. Service personnel detector 16 may be used to determine when service starts and/or when the environmental equipment unit is turned on again after being shut down. Such information may be implied the facts detected by programming, such as no previous equipment operation, and/or may require additional input. In this manner, the manufacturer will know for warranty purposes when service began and be able to determine whether the environmental equipment system is still under warranty. Service personnel detector 16 may be provided in numerous different constructions that vary in cost, complexity, amount of data supplied, and so forth. In a presently preferred embodiment, service personnel detector 16 may comprise a single mechanical switch or button. When the service personnel inspects/repairs the environmental equipment system, the service personnel simply pushes the button. Controller 12 and/or receiver/processor 14 may utilize a clock to determine the time/date of the moment the button is pushed by the service personnel, thereby verifying physical presence of the service provider at the environmental equipment installation. Thus, the clock is utilized to produce a time stamp related to the service, whether the service is an inspection, a repair, or both. To prevent or limit unauthorized use, the button may have a lockout such that it can only be activated once every twenty-four hours. Alternatively, the button may operate with a program defining a time period in which a particular number of button pushes must be made within a specified time period and are used to verify physical presence of an authorized service technician, e.g., twelve button pushes within a one-minute time period. In another embodiment, the button may be covered with a lock to prevent unauthorized use. In another embodiment, the button should be pressed when the service personnel arrives and when the service personnel leaves to provide the length of time of service on location, which may be used for verification purposes. If identity information is also provided as discussed below, then a record of how the service personnel spent his time can be generated such as how much time was spent on each location, the travel time between locations, the sequence in which the service personnel worked on the environmental equipment systems, and so forth.

For instance, a keypad may be provided with a code known by each service personnel whereby the data comprises not only the time/date of service but also may provide the identity of the certified service personnel. Other information may also be provided by input through a keypad such as the type of service or repair, time on location, items repaired, and the like, as desired. Alternatively, authorization cards with magnetic strip readers, bar code readers, tag readers, and the like may be utilized to quickly provide time/date/identity information without the need for any keypad input. In another embodiment, the service personnel detector may be carried by the service personnel. For instance, handheld computers that may contain the service personnel's schedule for the day, equipment needed for repairs, directions to the locations, and the like may be utilized by the service personnel and may have a bar code scanner or other means to verify physical presence and identity of the service personnel. It will be understood that those skilled in the art could design other electronic means for performing the above-described functions. For instance, other means could include GPS or the like mounted to the service truck to perform as service personnel detector 16, which verifies physical presence, time/date, amount of time at the location, and/or other information that may be required by regulations to verify that the equipment has been timely inspected/repaired. Thus, many possible electronic configurations may be utilized to provide the function of service personnel detector 16. A single button with a programmed lockout or time period for a specific number of button presses is a presently preferred embodiment due to the low cost.

Preferably, controller 12 provides a visual or auditory indication to the service personnel, such as an L.E.D. indicator, to verify that his/her presence has been detected and thus ensure that the correct data will be transmitted, as discussed hereinafter.

Central receiver 14 and/or website servers 18 may be utilized in accord with one preferred embodiment of the invention to accumulate data from a plurality of wastewater installations and/or other data producers for distribution and utilization of the data to verify regulatory compliance. FIG. 2 shows one possible basic configuration of such a system whereby a plurality of any number N of wastewater installations as indicated at 20, 22, and 24 communicate with web server 26. Web server 26 may distribute information by an efficient low-cost means to any number N of regulatory bodies as indicated at 28 and 30 and as discussed hereinafter. Web server 26 may also collect data from other sources, such as subscriber contract active/cancelled status, along with other service contract information or other data, from any number N of service companies as indicated at 32, 34, and 36 for each of the plurality of wastewater installations 20, 22, and 24. In one embodiment, service from installation 10 does not start until paid for by the service company who is required to service the wastewater installation of concern. Therefore, it may be assumed that the service company has already been paid by the owner for the service contract. Thus, reports related to service contracts to be forwarded to the regulatory body may be generated automatically based on whether monitoring services utilizing unit 10 has been paid for by the service company. In one embodiment, an independent third party may operate central receiver 14 and notify the environmental body if contracts for monitoring using central receiver 14 and unit 12 are not renewed as discussed in more detail subsequently.

With reference again to FIG. 1, receiver/processor 14 may be utilized to receive data from any number N of environmental equipment installations, such as thousands of wastewater treatment systems as indicated by 20, 22, and 24. In a preferred embodiment, receiver/processor 14 may also be utilized to contact any number N of service companies to notify the respective service company of an alarm from any particular environmental equipment installation that requires servicing and/or any other responsible or interested party such as homeowners. Alternatively, website 18 may be utilized to provide alarm notifications to interested parties such as the appropriate service company 38.

Receiver/processor 14 and website 18 may be combined and effectively operate utilizing common electronic equipment or may be located at different locations. Website 18 may be a website on the Internet, a network, or a bulletin board accessible through a modem, an ISP, or any other suitable means for communicating from computer to computer. Alternatively, and/or simultaneously with receiver/processor 14, website 18 may receive information directly from controller 12 as indicated by communication line 17 which may be a telephone computer link up or any other data communication channel.

In response to an alarm notification, receiver/processor 14 and/or website 18 may provide a central monitoring station that identifies the location, type of alarm event and, if required, immediate notification to any interested party such as a designated service company either from receiver/processor 14, from website 18, or by other suitable means, as discussed in more detail subsequently. Service calls detected by service personnel detector 16 that are designated as routine inspections are preferably time-stamped and logged without the need to provide immediate notification to the service company, unless otherwise requested by the service company or other interested parties, whereby such an option may be provided on website 18. Notification warnings may be sent from receiver/processor 14 and/or website 18 by e-mail/fax/pager/program to the appropriate service company and/or to other interested parties by other suitable means, if desired.

Although not the preferred embodiment, other communication interconnections may be utilized. For instance, transmitter 12 might also connect directly to service company 38 to provide a warning or notice of event as indicated by dotted communication line 39; however, in this case appropriate communications should be provided to update the records kept by receiver/processor 14. As one example for this configuration, transmitter 12 may also transmit event data to receiver/processor 14 and/or service company 38 may transmit data to receiver/processor 14 through solid communication line 41. Two-way communication may also be effected from maintenance entity 38 to controller 12 either by communication line 39 or communication line 41 to allow for testing, measurements, and controlling of the particular type of environmental installation involved. Other communication networks may be utilized for processing, forwarding, and storing data in accord with the methods of the invention as discussed herein.

Along with event data related to warnings, repairs, and inspections, receiver/processor 14 and/or website 18 may also receive and store data related to service contracts for each environmental installation and thereby automatically route the alarm to the correct environmental equipment installation. Receiver/processor 14 and/or website 18 stores the service contract data including renewal status and can send out renewal notices either directly to the homeowner or simply notify the appropriate service company. If the service contract is not renewed, as will normally be required by regulations, then receiver/processor 14 and/or website 18 stores this contract status information and preferably forwards or makes available the contract status information to regulatory agency 40. Responsible parties may also be notified. Regulatory agency 40 preferably may utilize software or systems in accord with the present invention that permit notification to the responsible parties, such as the homeowner and/or service company whose address and/or other contact information is stored by receiver/processor 14 and/or website 18, of noncompliance with regulations that require the homeowner to renew the service contract.

For example, in a preferred embodiment regulatory agency 40 may download form letters filled in and ready to mail. If desired, receiver/processor 14 and/or website 18 could also be utilized to automatically forward the form letter to the homeowner or responsible party on behalf of the regulatory agency and/or notify the agency by e-mail or other means that the noncompliance letter/e-mail/fax or the like has been sent and the date of mailing. Other types of communication besides form letters are also possible. When service contracts are renewed, the respective service company 38 notifies receiver/processor 14 and/or website 18 of the status, time period, particular installation, ownership and responsibility data, addresses, names, and so forth for the new contract. If monitoring utilizing unit 10 is not renewed, or if it is renewed, then such information may be implied while providing options to note changes. As discussed hereinafter, the respective service company and/or responsible party may simply fill out a suitable on-line form in a website to effect this action. If desired, verification of contract renewal and terms thereof can be sent by receiver/processor 14 and/or website 18 to the service company and homeowner or other responsible party by any messaging means such as fax, e-mail, or the like.

Regulatory agency 40 can also obtain status reports regarding timely repairs, e.g., the exact time when the sensor originally signaled that repair was necessary and the exact time when the service personnel actually arrived at the environmental equipment system location. Thus, in one embodiment of the invention a status report can be printed by regulatory agency 40 that includes all repairs that were not made within the required time or that may not have been made at all. If desired, different levels of urgency can be assigned to the situations based on the length of time the repairs are overdue, whether repairs have been made at all, and/or repair history for a particular installation, a particular service provider, or a particular service personnel. Thus, form letters covering the different status types can be sent out automatically from regulatory agency 40 to the responsible parties.

In a similar manner, regulatory agency 40 can conveniently monitor whether the inspections for the environmental equipment systems have been timely performed. Receiver/processor 14 and/or website 18 maintains the schedule required by regulations for inspection for each of the plurality of environmental systems and also records when service personnel has arrived at the location. Suitable means may be provided to determine whether a service call is for repair, for inspection, or for both in conjunction with service personnel detector 16. For instance, if no repair warning has been sent, the service call may be presumed by programming of receiver/processor 14 and/or website 18 to be a routine inspection. Thus, because data is available regarding when inspections are required, as well as when inspections have been made, regulatory agency 40 can determine, by automatic control, exactly what level of compliance with the regulations has been achieved. Again, automatic notifications to responsible parties can be sent out from the regulatory agency to the appropriate responsible entity for nonconformance. Such notices may go to the service company if it appears the service company did not perform as per the service contract requirements. If desired, conformance letters could also be sent out to those homeowners and service companies providing conforming service as proof of a history of past conformance to regulations and/or history of repairs, inspections, and services as may be desired by other parties such as purchasers of the houses, real estate agencies, and the like.

System 10 may be utilized to signal when a wastewater system has been taken out of service or when service is initiated for the first time after manufacture or after the system has been out of service for repairs.

To significantly aid service companies 38, website 18 may also be utilized by service companies 38 to provide a record and an easily accessible schedule for each environmental equipment system for which the service company provides service. This schedule can be utilized in setting up work schedules for service personnel and so forth and provides a significant bookkeeping/logistics convenience for service companies 38. Additional records for each equipment system, including past history, anticipated types of repairs, maps, and the like, might be accessible by the appropriate service company and/or its service personnel. The service company may also be able to track personnel, determine efficiencies, determine time on locations, and so forth as may be useful for improved management.

Responsible parties 37 (See FIG. 1) for the environmental systems, such as wastewater systems, or any number of homeowners 29 and 31 or any other responsible parties (See FIG. 2), will also appreciate the present invention which permits the homeowner or responsible party to view details such as past history, alarms, times of response, time on location, scheduled maintenance, and the like, for their own wastewater system through website 18 and/or web server 26 and/or any other suitable communication means available now or available in the future. For security reasons, access to website 18 is preferably limited for responsible parties to information about their own wastewater systems. Responsible party 37, such as a the homeowner, normally makes a service contract with and pays a service company to provide regular maintenance as well as make repairs within the required response time. It is normally difficult for the homeowner or responsible party to verify what has actually been done in return for the service contract payments. Without use of the present invention, service personnel often come and go without their presence being known by the homeowner. However, as discussed hereinbefore, system 10 automatically accumulates and records this information and may, if desired, provide this information to the homeowner or other responsible person. For instance, responsible parties or homeowners might log into website 18 such as through server 26 or otherwise communicate to obtain such information. In this way, for instance, the homeowner can determine when maintenance was required and when or whether the service company actually performed these services. As well, if an alarm occurs, then the homeowner can determine when or whether repairs were made. If available, more detailed information such as details about repairs, the name and number of the service person or persons assigned to do work, and the like can be provided online for the homeowners. If desired, system 14 may be utilized to send notifications/alerts to the homeowners or responsible parties of any type, e.g., notification that an alarm went off, notification that repairs were or were not made within the required time period, notification that scheduled maintenance was performed within the required time period or not, and so forth.

If desired, system 14 may also provide for online contracts or sales with service providers of choice whereby the homeowner or other responsible party can contract with, change contracts, or the like, with a desired service company online through website 18. Moreover system 14 may permit communications between the service companies and responsible parties concerning matters such as maintenance, contract information, repairs, complaints, commendations, and the like. If desired, service companies may place their own link on website 18 for advertising and the like. Thus, the present invention provides the capability for much greater oversight and control over the environmental systems, such as a wastewater system, by the responsible party.

Environmental equipment systems, such as wastewater systems, 20, 22, and 24, may be any environmental equipment system for which environmental related regulatory oversight is required. For instance, according to American National Standard/NSF International Standard definitions, a residential wastewater treatment system is considered to be an organized and coordinated system of components that functions to treat wastewater generated by individual residences. A subdivision may have a plurality of residential wastewater treatment systems, each of which has to be in compliance with environmental regulatory requirements. Each wastewater treatment system is then considered an environmental equipment system for purposes of the present specification. As used herein, servicing includes maintenance, inspection, repairs, or others type of labor-related services when environmental equipment systems are involved whether or not repairs are actually made, initiated, delayed, or completed, and even if no action is taken. Servicing may also include remote repairs and monitoring. Service personnel provide the labor of servicing that should be made in a timely manner. Depending on regulatory requirements, service personnel may be required to be authorized representatives. Service personnel may be comprised of organizations, groups, individuals, or other entities that may be required to be authorized to distribute sell, install, and/or service environmental equipment systems such as wastewater treatment systems. Service companies may typically provide such service personnel. Service companies may include organizations, groups, individuals, or other entities. Generally, an owner for each environmental equipment system maybe an individual, municipality, government, corporate, or other type of entity. The owner may typically be responsible for servicing such as the labor of maintenance/repairs/inspections and so forth of the environmental equipment system and may have contracted to have certified servicing performed by a service company utilizing certified personnel. The service company, which may be the owner's agent who has contracted to provide the service, may then also be a responsible party.

According to ISO Guide 2, which sets the internationally accepted definitions for product testing and certification, among many other things, the definition of a third-party is as follows: Person or body that is recognized as being independent of the parties involved, as concerns the issue in question. For instance NSF® is a third party that provides certification services but not does not sell the units or service the units in question. In one embodiment of the invention, receiver 14 and/or website 18 is operated by a third-party that reports to regulatory agency 40 regarding compliance or noncompliance with regulations. Preferably communications are automatic, but the third party may use any communication means including written reports and the like as may be utilized by the third-party to the regulatory body. The third-party is recognized as independent because the third party has no clear benefit if the duty to provide the labor of services such as repairs and inspections in accordance with regulations is not met. Preferably, the third-party receives payment for reliable reporting to thereby provide motivation to reliably and consistently report noncompliance. For instance, a manufacturer of environmental equipment and parts, who does not contract to provide services, does not have any clear benefit if inspections or maintenance or repairs are not properly made. Therefore a manufacturer is sufficiently independent to be third party for purposes of reporting noncompliance to regulations. This is so even though the manufacturer might in some cases be required, as a last resort, to supply some labor services under certain circumstances to maintain certification of the equipment, such as if a service company defaults on service contracts involving the equipment. Thus, a third party should be sufficiently independent of any motivation to avoid reporting noncompliance that a government body or certification body might reasonably recognize the third party as being independent. On the other hand, a service provider or environmental equipment system owner would not be independent because such parties could significantly benefit from cost savings if repairs or inspections are not made, or if the repairs/inspections are not made in a timely manner, or if the noncompliance with regulations was simply not reported. Thus, a third party would have no motivation to avoid reporting noncompliance with regulations and would not benefit by saving costs such as a service provider or system owner might. The main motivation for the third-party is to accurately track the actual status of compliance with regulations and the third-party may be paid for that service, just as other independent bodies such as companies such as NSF® are paid to provide independent certification. Thus, if desired, a third party entity, government body, or other independent company could be utilized to operate system 10 as a third party. For that matter, a purely automatic system may comply with the definition of a third-party because a machine has no motivation except to do that for which it is programmed. In this case, an independent third party might be required verify and certify operation of the machine to verify that the machine, such as system 10, is operating correctly to make accurate reports. Therefore, for purposes of the present specification a third-party may be an independent person, entity, or body, or may be a certified system such as system 10. A third party should be sufficiently independent that the third party does not benefit from noncompliance and should have a motivation to accurately report noncompliance with regulations. Such motivation might include as payment for accurate and reliable reporting. A third-party for this specification might therefore also comprise a system, such as system 10, or components thereof, owned and/or operated by an interested party if system 10 is certified or checked by an independent third-party and verified to act accurately and independently to determine whether or not the environmental regulations related to environmental equipment systems are being complied with.

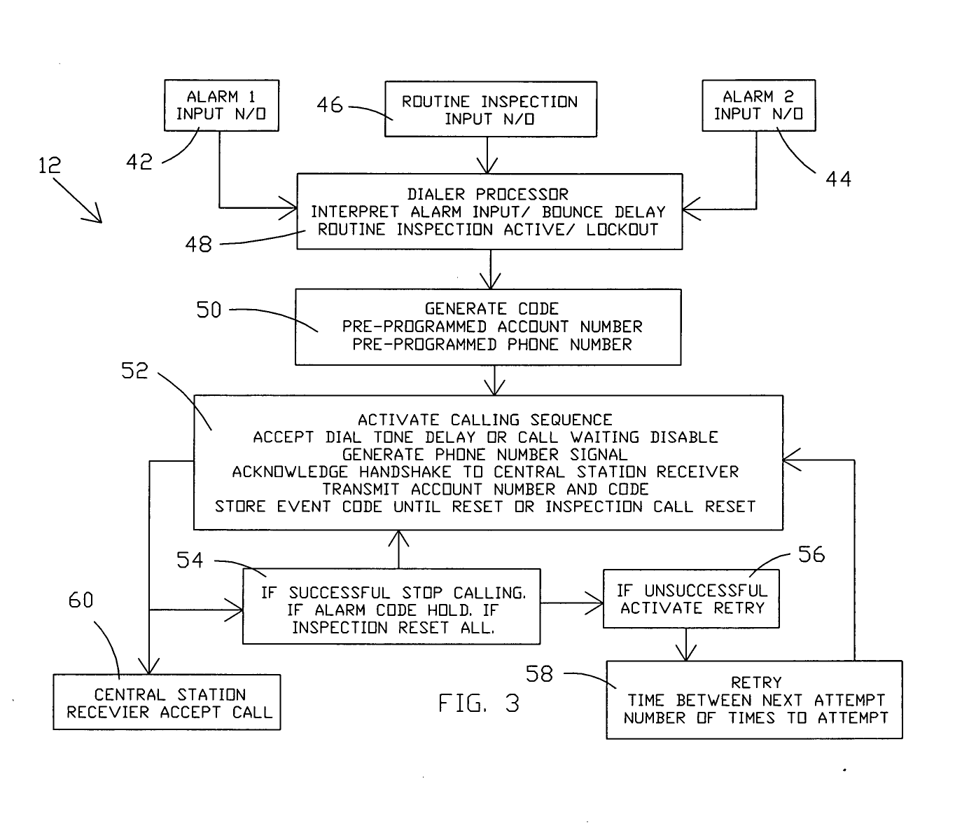

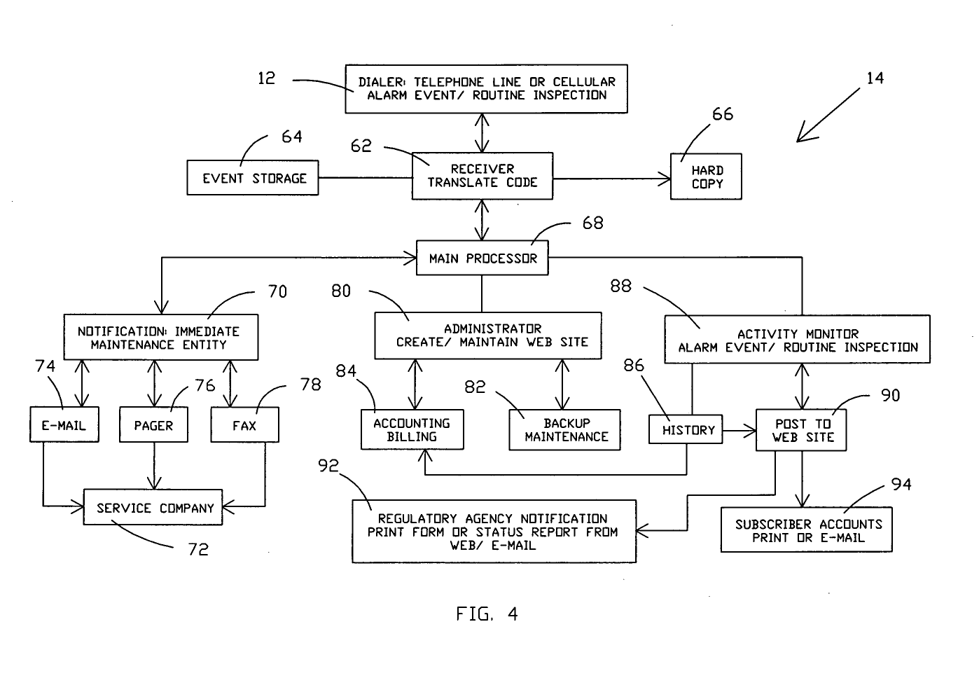

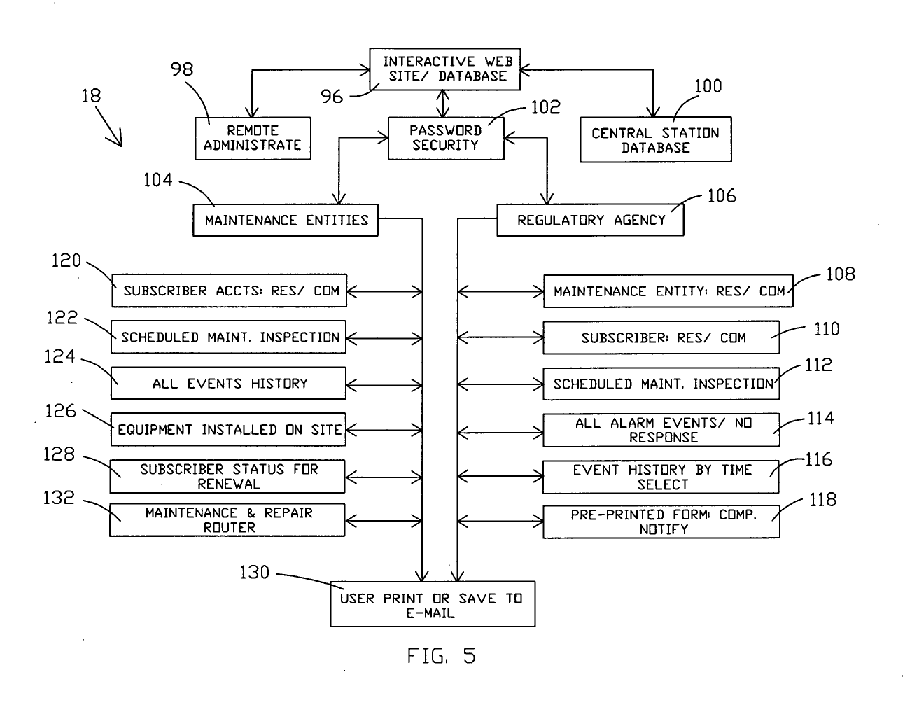

FIG. 3, FIG. 4, and FIG. 5 provide additional details for a presently preferred regulatory compliance system 10 as discussed in general terms hereinbefore in relation to FIG. 1 and FIG. 2.

FIG. 3 provides a schematical breakdown of certain features/functions of controller 12, such as the transmitter and/or dialer 12 functions. As indicated and discussed above, various types of inputs may be provided from sensors, such as equipment failure alarms 42 and 44. As discussed above, many different types of service personnel detectors 16 can be utilized to provide routine inspection/repair service call input 46. For example, alarms 42 may include two amperage sensors that sense over currents in engines in wastewater systems whereby less expensive service is needed before the engines break down and require major repairs. If a wastewater system has two engines that may be used alternatively, then the spare engine could be used while one engine is being repaired. Utilizing two over current sensors with one sensor one each engine would allow continued operation of the facility, while shutting down either engine that is drawing too much current. Dialer/processor 48 then sends a message to report the over current condition so that repairs can be made. Other controls shift the work load to the other engine.

For initial processing of event data, dialer/processor 48 may be programmed to sense short-term false alarms. For instance, with certain sensors a signal may occur that if monitored for a longer period, perhaps two minutes, will then go back to a normal range. For instance, a fluid level may rise momentarily above the trigger level but then soon drop back into the normal range whereby service is not indicated. Thus, false alarms can be reduced in some cases by programming delays and signal averaging into the design of dialer/processor 48. Thus, dialer/processor 48 may be utilized to interpret the alarm input and be programmed to respond accordingly. As another example, dialer/processor 48 may be utilized to provide bounce delays for a mechanical button or switch such as a programmed lockout time period or other means after an initial contact to verify that the service personnel actually activated the signal. Therefore, input 46, which may, for instance, be provided by personnel detector 16 (See also FIG. 1) may therefore be from a single switch or button, multiple switches such as a key pad, an electronic reader of some type, or any other means to indicate the actual physical presence of a service provider. Input 46 may also include data that identifies the particular service personnel such as a tag, magnetic strip, bar code, or the like.

Processor/dialer 48 or other components in receiver 14 of FIG. 1 may be utilized to determine the type of service provided by the service personnel, e.g., repair or routine inspection or both. Thus, processor 48 may refer to whether an alarm is active or not to interpret the meaning of the call. If a keypad is utilized, the service personnel could also indicate this information by inputting the appropriate code for either a repair service call, routine inspection, or both.

Dialer 50 may be used to send data to receiver 14 of FIG. 1 either by a standard telephone line or by cellular telephone where a standard telephone line is not available or by any suitable communication means. While a dialer is a low-cost embodiment in accord with a presently preferred embodiment, any other type of data communication line could be utilized. If desired, dialer 50 may utilize the telephone communications industry standard 4+2 format. Dialer 50 may in one embodiment utilize a code, such as a hexadecimal code or other type of code, that identifies a unique account number associated with the particular environmental equipment system, the alarm event, and/or the onsite report recognition of the physical presence of a service personnel. Dialer 50 may contain the phone number to be dialed in memory. The phone number may be changed by two-way communication from receiver 14, as desired. Account information will be transmitted that permits receiver 14 and/or website 18 to identify the particular environmental equipment system, type thereof, manufacturer, owner, installer, service contract status, service company, and so forth.

Programming of dialer 50 is indicated at blocks 52, 54, 56, 58, and 60 to thereby control the operation of dialer 50 in a presently preferred manner. For instance, the type of phone line connection may be programmed therein for receiver 14, handshake connections, protocol for data, decision-making as to resetting of alarms, and so forth. If a successful call is completed as indicated at 54, no further calls are needed, and depending on whether the code is for an alarm or for an inspection, a reset may or may not be made. If the call is not successful, as indicated at 56, then retry routine 58 may be activated whereby the time between the next retry is determined along with the number of retries attempted. For instance, phone lines may be down, and therefore routine 58 may delay further attempts until the next day after a certain number of attempts have been made. Busy signals may produce a different response. If receiver 14 accepts the call as indicated at 60, then the appropriate resets are made. While this program of operation is presently desired, other possible dialer operation formats may also be used.

FIG. 4 provides an overview of a presently preferred embodiment of receiver/processor 14. As discussed earlier, dialer 12, or another type of transmitter, sends data to receiver 62 by telephone lines, cellular transmission, or any other type of data link. Various communication checks such as parity checks, acknowledgments, and the like can be used to eliminate transmission of incorrect data.

While receiver 62 is preferably a single receiver, receiver 62 might also comprise multiple receivers that act together. For instance, there could be a separate receiver 62 for different geographical areas or countries, which then transmit the data to another receiver or group of receivers; however, in one presently preferred embodiment, all data is preferably stored in a manner to be accessible in real time by the regulatory body without the need to search multiple locations and/or repeatably update a plurality of remote data collecting systems 62 to a central station or website 18. The collected data, as discussed hereinbefore, relates to events that occur at each of a plurality of environmental equipment installations. Upon receipt, the data is translated by receiver 62 and the raw data is preferably stored in a data storage medium 64. Receiver 62 may also comprise a clock to time and date the receipt of each event. If desired, a time stamp may already have been attached to the event data from dialer 12, as discussed above. If no previous time stamp was produced, or even if one was produced, the time stamp of receiver 62 indicates when the data was received by receiver 62.

The time-stamp information is utilized to determine timely compliance with inspection requirements and repairs. If desired, a hard copy of all events for any desired period or for each event logged may be printed at 66. Main processor 68 is programmed to make decisions upon receipt of the data. For instance, if a warning event occurs such that repairs are necessary, then notification is made at 70. Processor 68 stores information that permits contacting the particular service company 72 that has an existing contract for servicing the particular environmental equipment system for which a repair warning event has been received.

Notification module 70 may comprise programmed equipment and/or may comprise a programming module operable to contact service company 72 by virtually any desired communication format such as, for instance, e-mail 74, pager 76, and/or fax 78. By communications with the website 18, the service company may have an option to select a desired communication means. In one embodiment, if desired, a selected service personnel could be directly paged by notification module for a particular group of environmental equipment, although service company 72 may typically prefer to have all communications go therethrough to continually update event logging records.

Main processor 68 may be programmed by system administrator 80, who may contact main processor 68 through website 18, by an Internet network connection, LAN, or another type of network connection. Alternately, system administrator 80 may contact or operate the website through main processor 68. Backup maintenance 82 for the system may be supplied depending on the particular configuration utilized and may comprise backup programs, data, and the like to restore the system in case of errors, power failures, and the like. Administrator 80 also preferably sets up accounting/billing module 84. Accounting/billing module 84 monitors the number of events from history module 86 and may determine pricing based on the number of data events that occur for each environmental equipment system in conjunction with other monthly fees and services provided.

Activity monitor 88 may be used to classify the events and store a log of events. For instance, the events received by receiver 62 might be classified as to whether they are alarm events, routine inspections, system start-up, system shut-down, contract renewal, and so forth. The cataloged data may be supplied to history module 86 where it may be utilized for accounting/billing purposes. Data may also be posted to website 18 as indicated at 90. In a preferred embodiment, from website 18 the regulatory agency can receive notifications, make inquiries, print forms, obtain status reports, and so forth as desired. The regulatory agency could also send messages to the respective homeowners, responsible parties, or service company through the website, as desired. Subscribers 94, such as service companies who subscribe to features such as schedulers that keep track of all inspection requirements for each unit, may also contact the website.

FIG. 5 provides an overview of various preferred functions of website 18 that may be produced by one or more servers and with data storage at one or more locations. Thus, interactive website/database 96 may comprise electronic equipment located at the same general location as receiver/processor 16 and/or be located at different locations. Thus, website 18 servers and receiver/processor 16 may or may not utilize common equipment, as desired, and may or may not be located at the same physical location.

An administrator may remotely operate interactive website 96 as indicated at 98. Website 18 may utilize central station database 100 for data storage and data backup storage, as desired. Preferably, access to website 98 is by unique password security as indicated at 102. Thus, each maintenance entity 104 and each regulatory agency 106 and if desired, each responsible party such as the homeowner has their own password. The passwords may preferably provide, or be associated with, different levels of access and/or services.

Items 108, 110, 112, 114, 116, and 118 give examples of some presently preferred services available to the regulatory agency in accord with the present invention. For instance, the regulatory agency may obtain service company information 108, such as listings of environmental units under contract, the make of the units, the dealer/installer, the address or physical location of the units, the history of service for the service company in percentages, noncompliance past history, and so forth. Likewise, owner information 110 is available, such as addresses and names or, if the owner is not responsible, other parties, such as operators, companies, or local governments. Likewise, a history of past events, responses, and so forth as well as a history of equipment failures may be obtained. This information may also be used as one factor in extended time verification of operation or for granting certification for certain types of units. Scheduled maintenance/inspection information 112 is readily available, and histories for each type of equipment can be obtained. From this and event information such as the physical presence data and/or data regarding classification as to inspection/repair visits, the regulatory agency can also determine whether inspections have been timely performed in compliance with the regulations. The regulatory agency can also obtain listings of all alarm events as indicated at 114, the times of the related responses, or whether any response has been made. Histories with respect to particular service companies and/or owners can also be obtained. Event histories may also be retrieved for particular time periods as indicated at 116. To reduce the time required for the regulatory agency, preprinted noncompliance forms can be produced at 118 that are addressed to the responsible parties. It will be understood that the data can be organized and retrieved in many different ways and formats and that many options may be provided for convenience and speed of operation by the regulatory agency. An oversight agency, through password supervision, may access accounts of a local agency and review their status. Searching may be made in many different ways such as by specific time period, name, equipment type, subscriber listings, service company, and so forth. Thus, the present invention also allows an oversight agency to review local agency compliance.

Likewise, service companies 104 can obtain many helpful and valuable services through interactive website 96 as indicated at 120, 122, 124, 126, 128, and 130. Moreover, service companies can enter a significant amount of data into website 96 for use by the service companies in the future for scheduling such as future inspections, future contract renewal requests for homeowners, and the like. Thus, at subscriber information 120, information about the service company is input including contact information, location, and so forth. Scheduled maintenance/inspection schedules are available at 122 and may be provided as a convenience for companies that might otherwise pay significant sums to develop or purchase software for scheduling purposes. The website may be used by companies to generate bills, renewal notices, service notices, and other comments or advisories to customers or other interested parties. In one embodiment, service personnel that are in a particular area for other reasons such as repairs may be able to log into or have the service company log into the scheduler to determine if efficiencies can be achieved by performing inspections while the service personnel is already in that area. Thus, scheduler function 122 is likely to reduce operating costs for the service company. Service companies may also be able to obtain event histories 124 relating to histories of operation, timely response, timely repair, records of repair for each service personnel and for each environmental equipment installation, types of installations, and so forth. If desired, the data may be limited to data related to those service companies' operations. The type of equipment installed on each site may be available at 126 along with repair/maintenance history and so forth. At 128, the service company inputs information about the subscriber contract status and may have preprinted forms mailed to the subscriber before the contract expires, with perhaps standardized warning letters to advise about regulations requiring renewal of the service contract. The users may print or save the above and other information to e-mail as desired as indicated at 130.

Another benefit to maintenance entities, if desired, is an online maintenance and repair scheduler and/or router 132. With this, the maintenance company and/or the serviceman directly can receive a daily (two days, weekly) schedule for each serviceman which includes the locations for the day and, if desired, one or more maps of any desired detail which shows driving directions to each location. The cost savings to the maintenance entity are significant.

Many options are available for customizing the work schedules to the needs of the maintenance company needs. For instance, driving times, anticipated on-site maintenance times, anticipated on-site repair times, and/or other factors, can automatically be considered when automatically generating the work schedule for each service person. Scheduler 132 may provide a route that preferably limits driving time, which information is available in many map programs, and maximizes on-site time, e.g., provides a route where adjacent locations are given priority. Scheduler 132 may also provide exceptions, e.g., repairs due to alarms that must be made within a short time period thereby necessitating a longer drive to make the repair within the desired time period. As well, if particular service personnel are in particular areas, then the program may use those personnel because those service personnel may more efficient than others. Scheduler 132 may operate to prepare a schedule based around the work schedule of each serviceperson. For instance, if a serviceperson works only a few hours one day, then scheduler 132 would provide a limited schedule to that service person that day. If a serviceperson is on vacation, then scheduler 132 may be programmed to automatically alter the schedules of other service personnel.

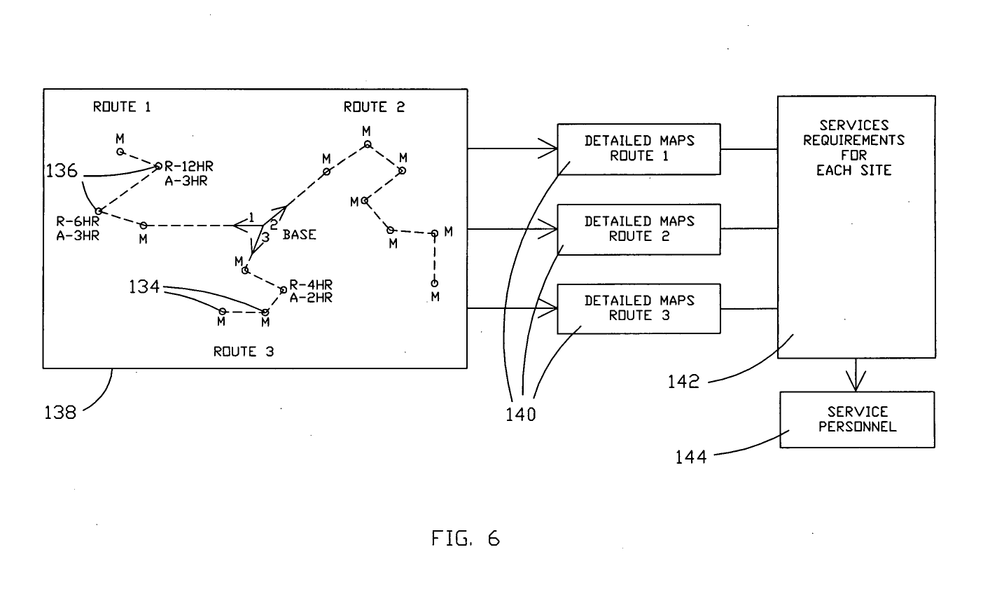

Scheduler 132 may also be interactively utilized. For instance, as one possible example only, FIG. 6 shows interactive daily schedule screen 138 of sites for which work is due. Sites where maintenance is due are marked with an “M,” a few of which are indicated by numeral 134. Sites where repairs are required are marked by “R” a few of which are indicated by numeral 136. Sites with repairs required are also shown with the remaining number of hours from the initial alarm in which the repairs are required to be made. If information is available, the anticipated time required on location for the repair is provided on the screen. Scheduler 132 may automatically draw route 1, route 2, route 3, and so forth, as indicated by the dotted lines. Alternatively, a supervisor may verify these routes or change them as desired or completely rework them. For instance, a supervisor may simply click on each site in a desired sequence to set up a route. Any site could be removed from that route by double clicking on the site.

Once the routes for the day are set up, then detailed maps can be automatically generated which give driving instructions, detailed maps for each site, and so forth, as indicated at 140. If the company utilizes GPS units for driving directions, then the locations of each site may be automatically or manually input into the associated GPS unit to provide driving instructions. As well, the required services, needs for special parts, and the like for each site may be provided as indicated at 142 and is given to the service personnel. Thus, the present invention provides a very convenient means for coordinating what needs to be done where, setting up a schedule for each service person, providing detailed driving instructions, and providing instructions as to what service is required for each site. The time and cost to service companies to do route scheduling without the present invention can be high. For this reason, the present invention is highly beneficial to the service companies.

Thus, in accord with the operation of the present invention, as discussed herein, a regulatory agency may set up an account having a password 102 to website 96 that enables the agency to view all accounts. If desired, only those accounts in noncompliance can be viewed and may be cataloged in various ways such as, for instance: alarm with no response, inspection not reported in a designated time period, or an account not actively in monitoring status. The present invention may verify compliance with standards such as the NSF International specification for third-party certification that requires that a wastewater treatment facility be repaired within 48 hours after an alarm. The present invention may also verify compliance with NSF International specifications that requires that a unit be inspected on a minimum semiannual basis. The present invention may also verify NSF International specifications requiring a service agreement to be renewed at least on an annual or biannual basis. Additionally, the regulatory agency is able to view the entity responsible for maintaining the equipment, the contact person, the telephone number, the equipment installed on location, and the history of all monitoring events. Should notification be necessary for noncompliance, a preprinted form maybe downloaded from the website with the subscriber's information automatically inserted into the form for mail-out. The service company also benefits by the present invention in that a password-protected account is available showing all subscriber accounts due for maintenance, contract renewal, service personnel records for those embodiments where the particular service person is identified, and an all-events history for the equipment.

Although a particular compliance system organization has been described, other computerized compliance system organizations could be used. For instance, each service personnel could have a handheld computer that communicates data to a desired location. Computer interconnections between the handheld computer and controller 12 could be made either by cable or wirelessly. The inspection data and details of repair may then be transferred by the handheld computer. Thus, the system may be set up quite differently and still effect the same functions and purposes. Each service company might set up a system that communicates between the service personnel, the unit, and a centralized data collection center whereby the data is available from all sources to the regulatory agency.

The foregoing disclosure and description of the invention is therefore illustrative and explanatory of a presently preferred embodiment of the invention and variations thereof, and it will be appreciated by those skilled in the art that various changes in the design, organization, order of operation, means of operation, equipment structures and location, methodology, and use of mechanical/electrical/software equivalents, as well as in the details of the illustrated construction or combinations of features of the various elements, may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views as desired for easier and quicker understanding or explanation of the invention. As well, the relative size and arrangement of the components may be greatly different from that shown and still operate within the spirit of the invention as described hereinbefore and in the appended claims. It will be seen that various changes and alternatives may be used that are contained within the spirit of the invention.

Accordingly, because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

1. A method for monitoring a plurality of environmental equipment systems with respect to timely servicing of said plurality of environmental equipment systems, said environmental equipment systems being serviced by one or more service personnel from one or more service companies, a plurality of responsible parties being responsible for payment to said one or more service companies for servicing of said plurality of environmental equipment systems, said method comprising:
electronically sensing repair status for said plurality of environmental equipment systems;
electronically producing a repair warning when repairs are required;
electronically storing inspection data related to scheduled inspection requirements of said one or more service personnel for each of said plurality of environmental equipment systems;
producing personnel data related to a physical presence of said one or more service personnel at said plurality of environmental equipment systems;
producing time stamp data comprising times of said repair warnings and times of said scheduled inspection requirements and times of said physical presence of said one or more service personnel for each of said plurality of environmental equipment systems;
automatically collecting repair status data, said personnel data, and said time stamp data; and
electronically providing access to said repair status data, said personnel data, and said time stamp data to said plurality of responsible parties.

2. The method of claim 1, wherein said step of producing time stamp data further comprises providing a physical presence sensor for sensing said physical presence of said one or more service personnel at each of said plurality of environmental equipment systems.

3. The method of claim 1, wherein said step of electronically providing access further comprises generating a website accessible by said plurality of responsible parties.

4. The method of claim 1, wherein said step of electronically providing access further comprises limiting said access for said plurality ofresponsible parties to only those of said plurality of environmental systems with which each of said plurality of responsible parties is associated.

5. The method of claim 1, further comprising:
electronically sending accumulated reports relating to said repair status data, said personnel data, said time stamp data, and said inspection data to at least one regulatory body having responsibilities concerning said plurality of environmental equipment systems.

6. The method of claim 1, further comprising:
generating notices related to noncompliance said timely servicing for transmission to said responsible parties.

7. The method of claim 1, further comprising:
generating noncompliance notices indicating failure to renew service contracts.

8. The method of claim 1, further comprising:
producing a daily route for said one or more service personnel to perform said timely servicing for respective of said plurality of environmental equipment systems.

9. The method of claim 8, further comprising generating a map to particular locations on said daily route for respective of said plurality of environmental equipment systems.

10. A monitoring system for a plurality of environmental equipment systems operable for monitoring said plurality of environmental equipment systems with respect to timely servicing of said plurality of environmental equipment systems, said environmental equipment systems being serviced by one or more service personnel from one or more service companies, a plurality of responsible parties being responsible for payment to said one or more service companies for said plurality of environmental equipment systems, a regulatory body for monitoring said plurality of environmental equipment systems, said system comprising:
an electronic monitor operable for monitoring repair status of each of said plurality of environmental equipment systems and for producing a warning that repairs are required;
at least one data storage element for electronically storing when said repairs are required and when said repairs are made, said at least one data storage element being further operable for storing when scheduled maintenance is required and when said scheduled maintenance is made; and
electronic linkage with said one or more service companies, said plurality of responsible parties, and said regulatory body, said electronic linkage permitting said responsible parties to determine whether said scheduled maintenance and said repairs are timely made.

11. The monitoring system of claim 10, further comprising a physical presence detector for producing personnel data related to a physical presence of said one or more service personnel at said plurality of environmental equipment systems for determining when said repairs and said scheduled maintenance are made.

12. The monitoring system of claim 10, wherein said at least one data storage element is operable to store information about said plurality of responsible parties comprising address information for contacting each of said plurality of responsible parties about respective of said plurality of environmental equipment systems.

13. The monitoring system of claim 10, wherein said electronic linkage comprises a web server operable to produce a website accessible by said plurality of responsible parties.

14. The monitoring system of claim 10, wherein said electronic linkage comprises a web server operable to produce a website accessible by said one or more service companies, and said regulatory body.

15. The monitoring system of claim 14, wherein said website comprises selectable options for said regulatory body for generating information related to compliance or noncompliance with scheduled inspection requirements and timely repair requirements for said plurality of environmental equipment systems.

16. The monitoring system of claim 14, wherein said website comprises selectable option for said one or more service companies for producing service schedules for said one or more service personnel for timely servicing of said plurality of environmental systems.

17. The monitoring system of claim 16, wherein said website comprises an option for generating a map with each service schedule for locations of respective of said plurality of environmental systems.

18. A method for servicing a plurality of environmental equipment systems, said environmental equipment systems being serviced by a plurality of service companies, a plurality of responsible parties being responsible for payment to said one or more service companies for servicing of said plurality of environmental equipment systems, said method comprising:
electronically sensing repair status of each of said plurality of environmental equipment systems;
automatically producing a warning when repairs are required for each of said plurality of environmental equipment systems;
automatically storing time data relating to each said warning;
electronically storing inspection data related to scheduled inspection requirements of said one or more service personnel for each of said plurality of environmental equipment systems; and
generating a web site accessible by each of said plurality of service companies, said website being accessible by said plurality of service companies to retrieve service data relating to when and where repairs and servicing of said plurality of environmental equipment systems is due.

19. The method of claim 18, further comprising selectively automatically generating a service schedule for one or more service personnel based on said service data which provides a list of environmental equipment systems where service is presently due.

20. The method of claim 18, further comprising selectively automatically generating a plurality of service schedules for each of a plurality of service personnel, wherein each service schedule provides a different list of environmental equipment systems to be serviced by particular service personnel during a particular time period.

21. The method of claim 20, further comprising selectively generating maps for a location of each environmental equipment system for each of said service schedules.

22. The method of claim 20, further comprising selectively automatically generating a travel route to environmental equipment system for each service schedule of each service person.

23. The method of claim 18, further comprising electrically detecting a time and date of a presence of service personnel at each of said plurality of environmental equipment systems, providing access to this information to said plurality of service companies.

24. The method of claim 23, further comprising providing access to said website to said responsible parties so that said responsible parties can determine whether maintenance and repairs were made within required times.

25. A servicing system for a plurality of environmental equipment systems, said environmental equipment systems being serviced by a plurality of service companies, each of said plurality of service companies comprising service personnel, said system comprising:
an electronic monitor for monitoring repair status of each of said plurality of environmental equipment systems and for producing a warning that repairs are required;
at least one data storage element for electronically storing when said repairs are required and when scheduled maintenance is required;
electronic linkage with said plurality of service companies whereby access to service data relating to when said repairs are required and when scheduled maintenance is required;
a scheduler operable for automatically utilizing said service data retrieved through said electronic linkage to selectively generate a plurality of service schedules for said service personnel at each of said plurality of service companies, each service schedule comprising a separate list of environmental equipment systems requiring service.

26. The servicing system of claim 25, wherein said scheduler is operable for selecting environmental equipment systems for each of said plurality of service schedules based on their physical location.

27. The servicing system of claim 26, wherein said scheduler is operable to group proximately located environmental equipment systems together in producing said service schedules.

28. The servicing system of claim 25, wherein said scheduler is operable to automatically generate a proposed route for traveling to each environmental equipment system on a respective service schedule.

29. The servicing system of claim 28, wherein said automatically generated proposed route is modifiable by a user.

30. The servicing system of claim 25, wherein said scheduler is operable to generate a map for each environmental equipment system on a respective service schedule.

31. The servicing system of claim 25, wherein said scheduler is operable to list whether repairs or maintenance is required for each environmental equipment system on a respective service schedule.

32. The servicing system of claim 25, further comprising an electric physical presence detector for producing personnel data related to when said service personnel are present at said plurality of environmental equipment systems.

33. The servicing system of claim 25, wherein said electronic linkage comprises a web server operable to produce a website accessible by said plurality of service companies.

34. The monitoring system of claim 33, wherein said scheduler is available on said website.
